(19) United States
(12) Patent Application Publication
(10) Pub. No.: US 2024/0304166 A1
(43) Pub. Date: Sep. 12, 2024

(54) Electronic Cymbal

(71) Applicant: Ef-Note Inc., Hamamatsu-shi (JP)

(72) Inventor: Yoshiaki MORI, Hamamatsu-shi (JP)

(21) Appl. No.: 18/668,761

(22) Filed: May 20, 2024

Related U.S. Application Data
(63) Continuation of application No. PCT/JP2022/040565, filed on Oct. 28, 2022.

(30) Foreign Application Priority Data
Dec. 1, 2021 (JP) 2021-195708

(51) Int. Cl. G10D 13/063; G10D 13/10

(52) U.S. Cl. CPC G10D 13/063; G10D 13/26

(57) ABSTRACT

An electronic cymbal has electronic cymbal bodies (1, 2), with pads 3, having a hitting surface F that a player can hit, and frames 4, each supporting the back surface side of the pad 3. Opening parts (3a, 4a) are formed at the centers of the pad 3 and the frame 4 of the electronic cymbal body 1. A vibration sensor 5 detects a hit on the hitting surface F of the pad 3. Output cables (7a, 7b), connected to the vibration sensors 5, transmit output from detection signals detected by the vibration sensors 5. The electronic cymbal has an insertion groove part 4b that communicates with the opening part 4a of the frame 4 where the output cable 7b can be held while being inserted through the insertion groove part 4b.

### CROSS-REFERENCE TO RELATED APPLICATIONS

This application is a continuation of International Application No. PCT/JP2022/040565, filed Oct. 28, 2022, which claims priority to Japanese Application No. 2021-195708, Dec. 1, 2021. The disclosures of the above applications are incorporating herein by reference.

### FIELD

The present disclosure relates to an electronic cymbal with a detection sensor capable of detecting a hit that can output a detected detection signal.

### BACKGROUND

A known electronic cymbal, for example, as disclosed in Unexamined Patent Application Publication No. 2005-331972, includes an electronic cymbal body with a pad having a hitting surface that a player can hit and a frame supporting the back surface side of the pad. A vibration sensor detects a hit on the hitting surface of the pad. An output cable externally outputs a detection signal detected by the vibration sensor. When a player hits the hitting surface of the electronic cymbal body with a stick, the vibration sensor detects the hit, external output can be performed, and similar performances to acoustic cymbal performances can be achieved.

### SUMMARY

However, in the related art described above, the output cable extends from the back surface of the frame. Thus, for example, when electronic cymbal bodies are arranged vertically at plural levels, the output cable extending from the electronic cymbal body at an upper level becomes an obstacle for the electronic cymbal body at a lower level. Thus, this causes problems such as erroneous detection of a hit and performance interference. In addition, for example, when an electronic cymbal body is disposed in a suspended state, the output cable is routed in midair, thereby causing a problem such as performance interference due to appearance degradation.

The present disclosure has been made in view of above-described circumstances. It provides an electronic cymbal where a problem during a performance can be avoided by holding an output cable even when electronic cymbal bodies are arranged vertically at plural levels or even when an electronic cymbal body is disposed in a suspended state.

The disclosure is an electronic cymbal comprising an electronic cymbal body with a pad, having a hitting surface that a player can hit, and a frame, supporting a back surface side of the pad. Opening parts are formed at centers of the pad and the frame of the electronic cymbal body. A supporting stand can be inserted through the openings. A detection sensor detects a hit on the hitting surface of the pad. An output cable is connected to the detection sensor. A detection signal is detected by the detection sensor and is output by the cable. The electronic cymbal has an insertion groove part that is formed so as to communicate with the opening part of the frame. The output cable can be held while being inserted through the insertion groove part.

In the electronic cymbal, the insertion groove part is formed in a periphery of the opening part formed in the frame. A shaft sleeve is attached while being interposed between the opening part of the frame and the supporting stand.

In the electronic cymbal, the shaft sleeve has a slit at a position corresponding to the insertion groove part. The output cable is inserted through the insertion groove part via the slit.

In the electronic cymbal, a shaft sleeve is attached to the opening part formed in the frame. The insertion groove part is formed in the shaft sleeve.

In the electronic cymbal, a retaining shape is formed for retaining the output cable inserted through the insertion groove part.

In the electronic cymbal, a plurality of the electronic cymbal bodies are supported by the supporting stand vertically at a plurality of levels. The output cable, extending from the electronic cymbal body at an upper level, is inserted through the insertion groove part of the electronic cymbal body at a lower level.

In the electronic cymbal, the electronic cymbal body is suspended from and supported by the supporting stand. The output cable, extending from the electronic cymbal body, is inserted through the insertion groove part.

According to the disclosure, the insertion groove part is provided so as to communicate with the opening part of the frame. Also, the output cable can be held while being inserted through the insertion groove part. Thus, a problem during a performance can be avoided by holding the output cable even when the electronic cymbal includes a plurality of the electronic cymbal bodies arranged vertically at a plurality of levels or even when the electronic cymbal body is disposed in a suspended state.

According to the disclosure, the insertion groove part is formed in the periphery of the opening part formed in the frame. The shaft sleeve is attached while being interposed between the opening part of the frame and the supporting stand. Thus, the shaft sleeve can reliably hold the output cable inserted inside the insertion groove part.

According to the disclosure, the shaft sleeve has the slit at a position corresponding to the insertion groove part. The output cable can be inserted through the insertion groove part via the slit. Thus, the output cable can be held inside the insertion groove part while being inserted through the insertion groove part via the slit. Accordingly, assembling workability can be improved.

According to the disclosure, the shaft sleeve is attached to the opening part formed in the frame, and the shaft sleeve has the insertion groove part. Thus, the output cable can be held in the insertion groove part of the shaft sleeve without forming an insertion groove part in the electronic cymbal body.

According to the disclosure, the retaining shape is formed to retain the output cable inserted through the insertion groove part. Thus, the output cable, inserted inside the insertion groove part, can be held more reliably.

According to the disclosure, the electronic cymbal bodies are vertically supported by the supporting stand at plural levels. The output cable, extending from the electronic cymbal body at the upper level, is inserted through the insertion groove part of the electronic cymbal body at the lower level. Thus, the output cable, extending from the electronic cymbal body at the upper level, can be held in the insertion groove part. Thus, erroneous detection of the detection sensor and performance interference can be prevented.

According to the disclosure, the electronic cymbal body is suspended from and supported by the supporting stand. The output cable, extending from the electronic cymbal body, is inserted through the insertion groove part. Thus, the output cable, extending from the suspended electronic cymbal body, can be held in the insertion groove part. Accordingly, appearance degradation and performance interference can be prevented.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the entire exterior of an electronic cymbal according to a first embodiment.

FIG. 2 is a front view and a plan view of the electronic cymbal.

FIG. 3 is a sectional view taken along line III-III in FIG. 2.

FIG. 4 is a sectional view taken along line IV-IV in FIG. 2.

FIG. 5 includes a top and bottom plan view of an electronic cymbal body of the electronic cymbal (before the rotation of a shaft sleeve).

FIG. 6 includes a top and bottom plan view of the electronic cymbal body of the electronic cymbal (after the rotation of the shaft sleeve).

FIG. 7 is an exploded perspective view of the electronic cymbal body.

FIG. 8 is a three-side, top bottom plan and side elevation, view of a pad of the electronic cymbal body.

FIG. 9 is a three-side, top bottom plan and side elevation, view of a frame of the electronic cymbal body.

FIG. 10 is a three-side, top bottom plan and side elevation, view of a shaft sleeve to be attached to the electronic cymbal body.

FIG. 11 is a perspective view of the entire exterior of an electronic cymbal according to a second embodiment.

FIG. 12 is a front side view and a top plan view of the electronic cymbal.

FIG. 13 is a sectional view taken along line XIII-XIII in FIG. 12.

FIG. 14 is a sectional view taken along line XIV-XIV in FIG. 12.

FIG. 15 is a top and bottom plan view of another embodiment with a shaft sleeve without a slit.

FIG. 16 is a top and bottom plan view of another embodiment with a shaft sleeve having an insertion groove part.

FIG. 17 is a top and bottom plan view of another embodiment with an insertion groove part provided with a narrow part.

FIG. 18 is a top and bottom plan view of another embodiment with an insertion groove part having an L shape.

### DETAILED DESCRIPTION

Hereinafter, embodiments of the present disclosure will be concretely described with reference to the drawings.

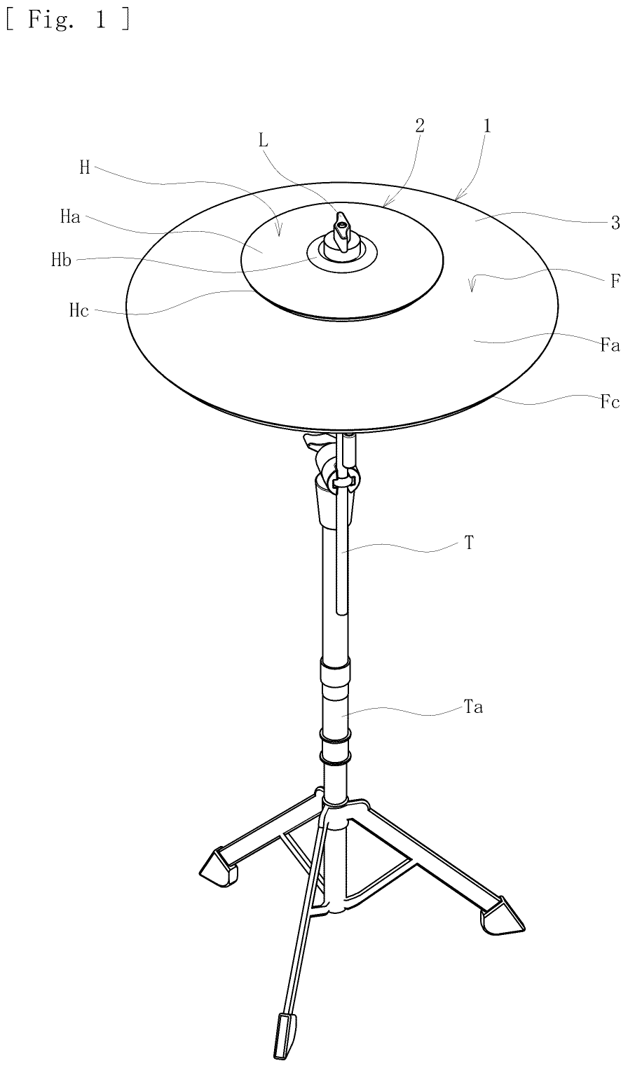

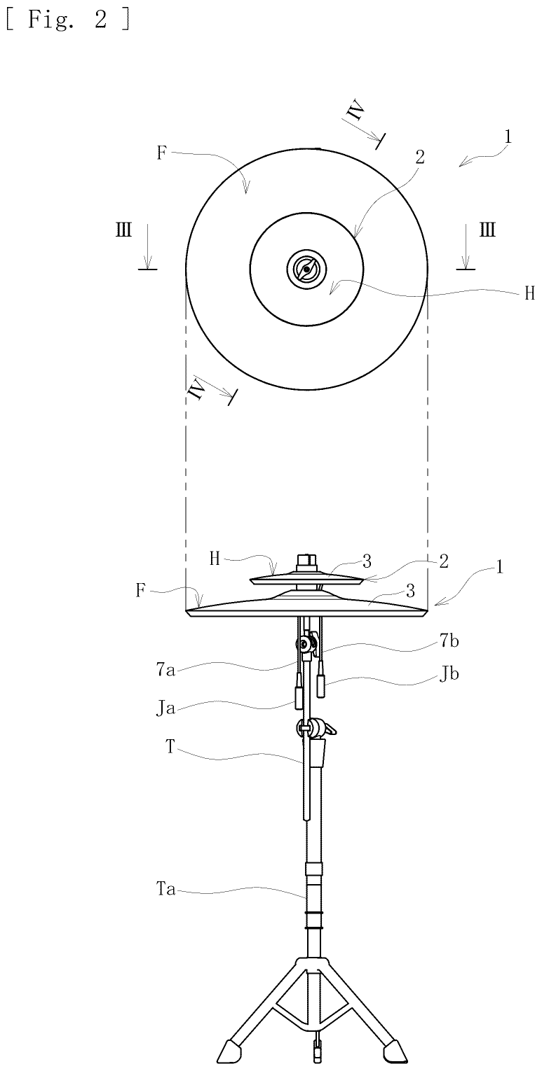

An electronic cymbal according to a first embodiment includes, as illustrated in FIGS. 1 to 4, an electronic cymbal body 1 and an electronic cymbal body 2, arranged at two upper and lower levels, a vibration sensor 5, detection sensor, and a shaft sleeve 8 that is disposed in each of the electronic cymbal body 1 and the electronic cymbal body 2, and a covering member 9.

The electronic cymbal body 1 is disposed at a position below the electronic cymbal body 2. It is supported at a predetermined height by a supporting stand T extended vertically by a stand leg part Ta. The electronic cymbal body 1 includes a pad 3, having a hitting surface F that a player can hit, and a frame 4, supporting the back surface side of the pad 3. The electronic cymbal body 2 is disposed at a position above the electronic cymbal body 1. It includes a pad 3, having a hitting surface H that a player can hit, and a frame 4, supporting the back surface side of the pad 3.

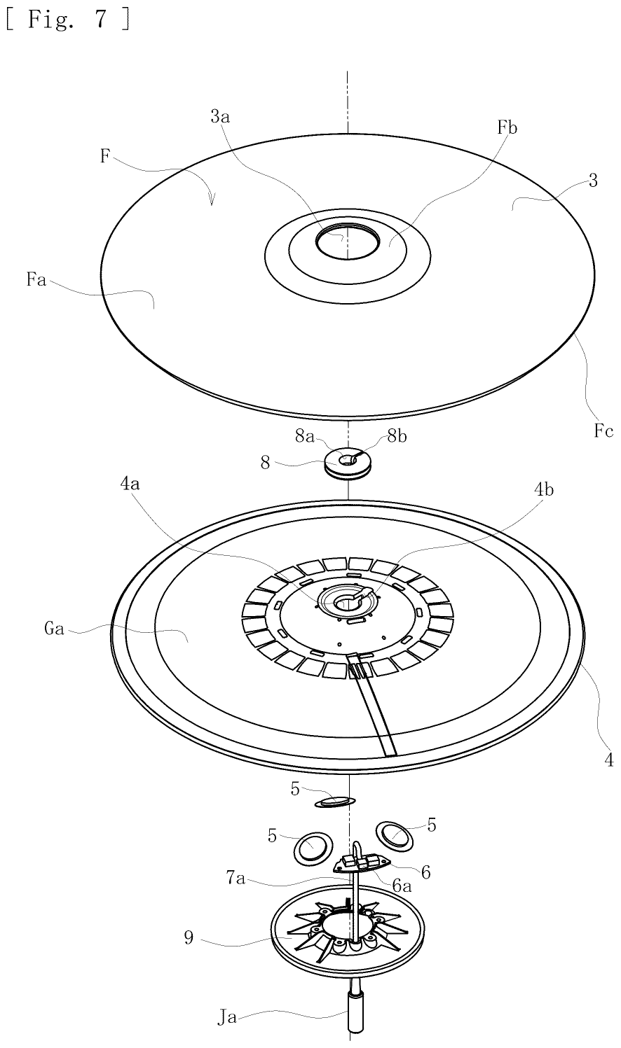

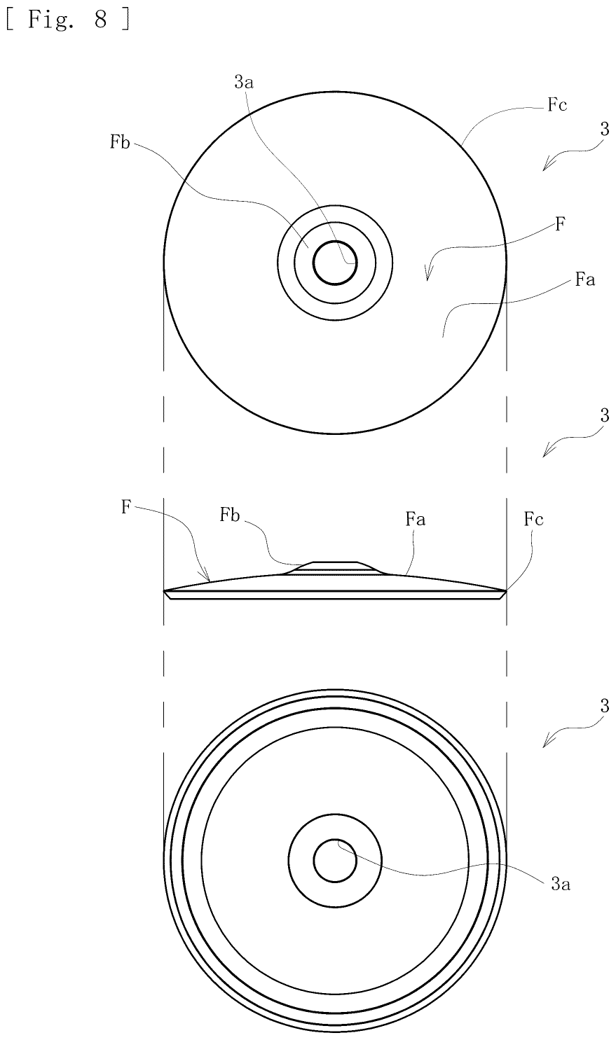

Each of the pads 3 is made of a material such as a rubber material or a soft resin (in the present embodiment, a silicone rubber) that can be hit with a stick. As illustrated in FIGS. 7 and 8, the pad 3 is constituted by a disk-shaped member with, at a center position, an opening part 3a through which the supporting stand T can be inserted. The hitting surfaces F and H, formed in upper surfaces of the pads 3, have cup parts Fb and Hb formed in protruding portions at the centers of the pads 3. Edge parts Fc and Hc are formed in peripheral portions of the pads 3. Bow parts Fa and Ha form a region between the cup part Fb and the edge part Fc and a region between the cup part Hb and the edge part Hc, respectively.

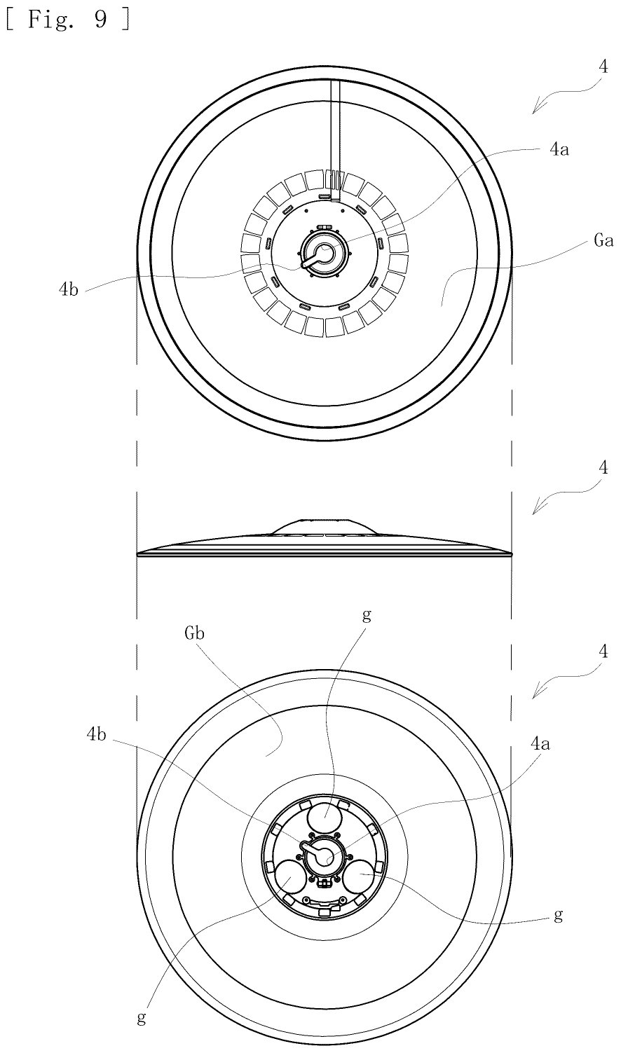

Each of the frames 4 is made of a resin or a metal (in the present embodiment, a hard resin). As illustrated in FIGS. 7 and 9, the frame 4 is constituted by a disk-shaped member with, at a center position, an opening part 4a through which the supporting stand T can be inserted. In addition, the pad 3 is mounted on and integrated with a front surface Ga of the frame 4 into the electronic cymbal body 1. Plural mounting parts g, each for mounting the vibration sensor 5, (refer to FIG. 7) are formed on the back surface Gb side. The plural mounting parts g are formed at positions that are rotationally symmetrical about the central axis of the frame 4. Each one is formed at a position that is on the same circumference around the central axis of the frame 4.

The covering member 9 is mounted on the back surface Gb side of the frame 4 to cover the vibration sensors 5 and other components. A substrate 6 (refer to FIG. 7), including a predetermined electric circuit, is mounted on the covering member 9. Each of the vibration sensors 5 is constituted by a sensor that can detect a hit on the hitting surface F of the pad 3. In the present embodiment, the vibration sensor 5 is mounted on the mounting part g on the back surface Gb side of the frame 4. It detects vibrations of the frame 4 thereby being able to detect a hit on the pad 3.

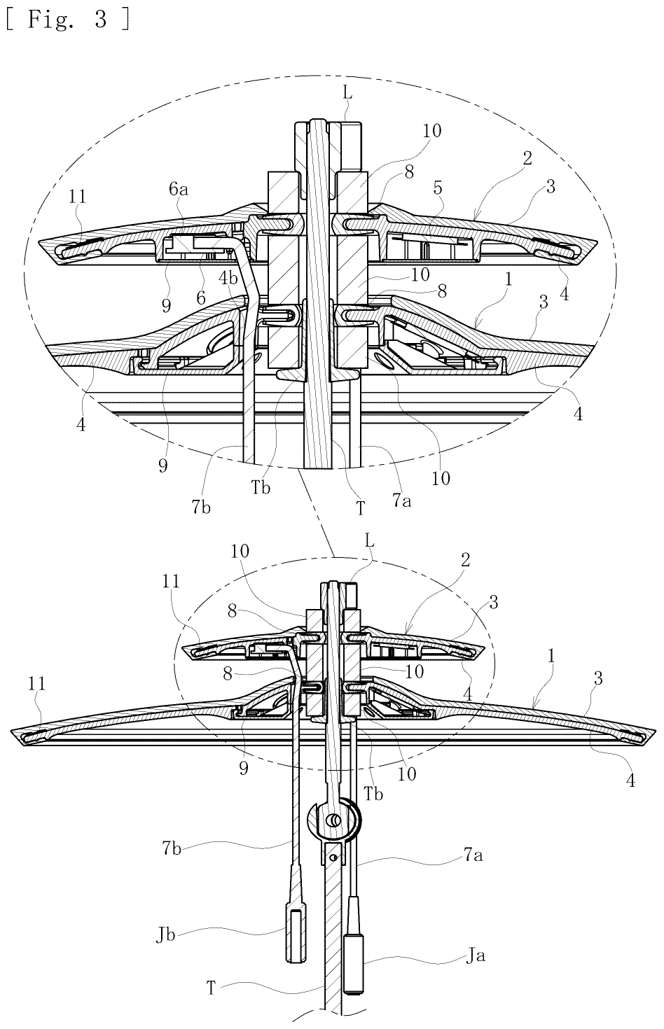

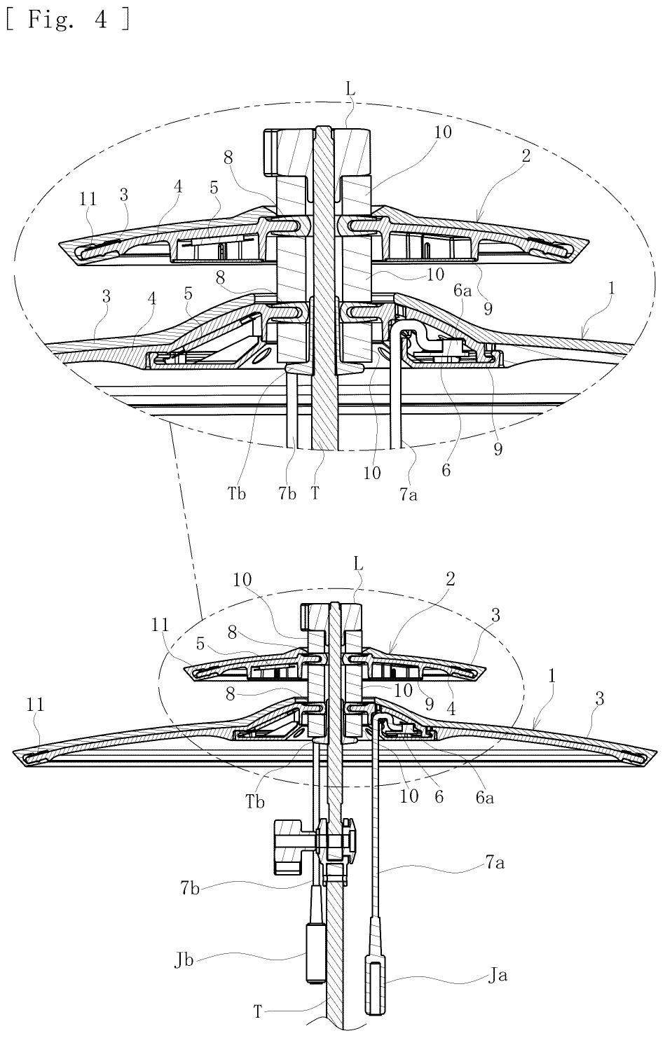

The vibration sensor 5 is electrically connected to the substrate 6 mounted on the covering member 9. When the vibration sensor 5 detects a hit on the hitting surface F of the pad 3, a detection signal of the detection is transmitted to the substrate 6. Note that an edge sensor 11 (FIGS. 3 and 4) is mounted on the periphery, on the front surface Ga side of the frame 4. It can detect a hit on the edge part Fc of the pad 3. As with the vibration sensor 5, the edge sensor 11 is electrically connected to the substrate 6. A detection signal is transmitted to the substrate 6.

In addition, a connector 6a is formed on the substrate 6. A proximal end of an output cable 7a is attached to the connector 6a. The output cable 7a is connected to the vibration sensor 5 and the edge sensor 11 by using the substrate 6. This enables the detection signals, detected by the vibration sensor 5 and the edge sensor 11, to be externally output. Moreover, the output cable 7a has an output jack Ja at a distal end thereof and can thus be connected to an external signal processing device (not illustrated).

When a player hits the hitting surface F of the pad 3 with a stick and vibrates the electronic cymbal body 1, the vibration sensor 5 detects the strength of the hit. An electrical signal, according to the strength of the hit, is output to the external signal processing device (not illustrated) through the output cable 7a and the output jack Ja. Note that a hit on the edge part Fc is identified depending on the ON and OFF states of the edge sensor 11. Thus, when a hit is detected with the edge sensor 11 being OFF, it is determined that the bow part Fa or the cup part Fb has been hit, and output is performed.

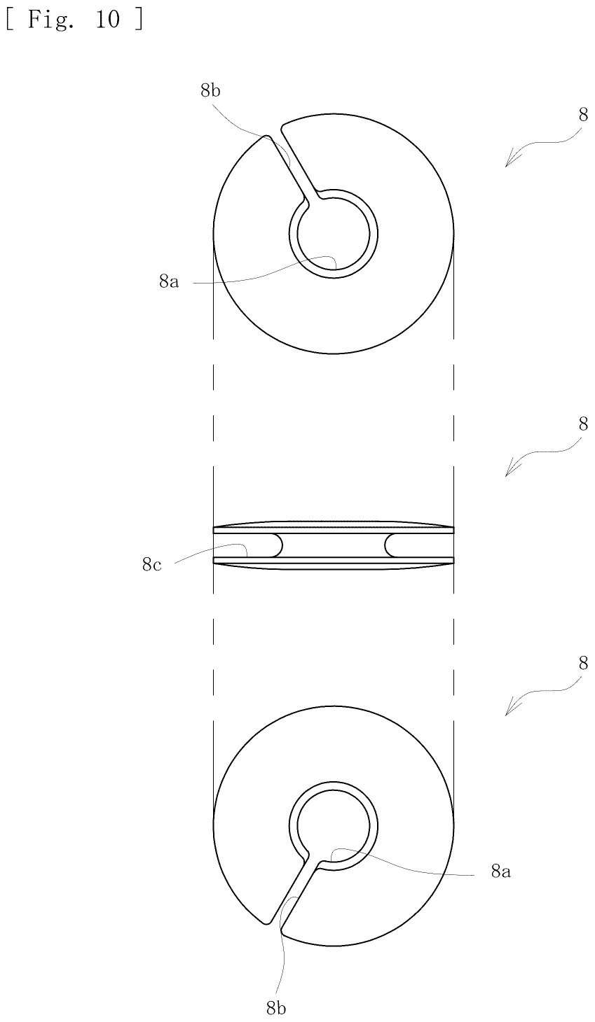

As illustrated in FIG. 10, the shaft sleeve 8 is constituted by a cylindrical elastic member (in the present embodiment, a rubber material) with a central hole 8a in a center portion. As illustrated in FIG. 10, the shaft sleeve 8 has a slit 8b extending from the central hole 8a to the outer periphery. In its side, a groove shape 8c is formed circumferentially along the entire shaft sleeve 8. However, as illustrated in FIGS. 3 and 4, the shaft sleeve 8 is attached while being interposed between the opening part 4a of the frame 4 and the supporting stand T. In the present embodiment, a stand sleeve Tb is provided for the supporting stand T.

Specifically, the shaft sleeve 8 is attached by fitting the groove shape 8c, which is formed in the side of the shaft sleeve 8, onto the periphery of the opening part 4a of the frame 4. It is supported while the stand sleeve Tb and the supporting stand T is inserted through the central hole 8a. In addition, felt members 10 are mounted above and below the shaft sleeve 8. This suppresses the vibrations caused by a hit from being transmitted to the supporting stand T and the electronic cymbal body 2, positioned above. Note that a reference sign L in the figures denotes a tightening member for tightening and fixing the electronic cymbal bodies 1, 2 to the supporting stand T.

The electronic cymbal body 2 has a similar configuration to that of the electronic cymbal body 1 and is set to have a size smaller than that of the electronic cymbal body 1, in plan view. The electronic cymbal body 2 is configured by integrating the pad 3, having the opening part 3a, with the frame 4, having the opening part 4a. Also, it is provided with a vibration sensor 5 and a substrate 6 that are similar to those of the electronic cymbal body 1. As with the electronic cymbal body 1, the electronic cymbal body 2 includes a shaft sleeve 8 attached to the opening part 4a of the frame 4. It is supported by the supporting stand T with the shaft sleeve 8 interposed therebetween.

The electronic cymbal bodies 1, 2 are supported by the supporting stand T vertically at plural levels (in the present embodiment, two levels). An output cable 7b, for externally outputting a detection signal, extends from the substrate 6 of the electronic cymbal body 2 positioned at the upper level. An output jack Jb, formed at a distal end of the output cable 7b, is connected to the external signal processing device (not illustrated).

Here, as illustrated in FIG. 3, the electronic cymbal body 1, according to the present embodiment, has an insertion groove part 4b. The opening diameter is, for example, about 5 mm. The groove part 4b is formed so as to communicate with the opening part 4a of the frame 4. The output cable 7b, of the electronic cymbal body 2, can be held while being inserted therethrough. The insertion groove part 4b is constituted by a cutout formed in the periphery of the opening part 4a formed in the frame 4. The opening diameter is, for example, about 20 mm. The shaft sleeve 8 is attached while being interposed between the opening part 4a of the frame 4 and the supporting stand T of the stand sleeve Tb.

The electronic cymbal bodies 1, 2 according to the present embodiment are supported by the supporting stand T vertically at plural levels (two levels). The output cable 7b, extending from the electronic cymbal body 2 at the upper level, is inserted through the insertion groove part 4b of the electronic cymbal body 1 at the lower level. Thus, the output cable 7b, extending from the electronic cymbal body 2 at the upper level, can be reliably held at a center position of the electronic cymbal body 1 at the lower level. This prevents the cable from becoming an obstacle for the hitting surface F during a performance.

In particular, because the insertion groove part 4b is formed in an edge portion of the opening of the opening part 4a, the output jack Jb can be inserted from the top to the bottom of the electronic cymbal body 1 by using the opening part 4a in a process of inserting the output cable 7b through the insertion groove part 4b. Thus, no through hole, for inserting the output cable 7b, is required in a portion of the hitting surface F. In addition, because the shaft sleeve 8 is attached while being interposed between the opening part 4a of the frame 4 and the supporting stand T (the stand sleeve Tb), the output cable 7b, inserted through the insertion groove part 4b, can be prevented from moving to the supporting stand T side and can thus be avoided from gripping the felt member 10.

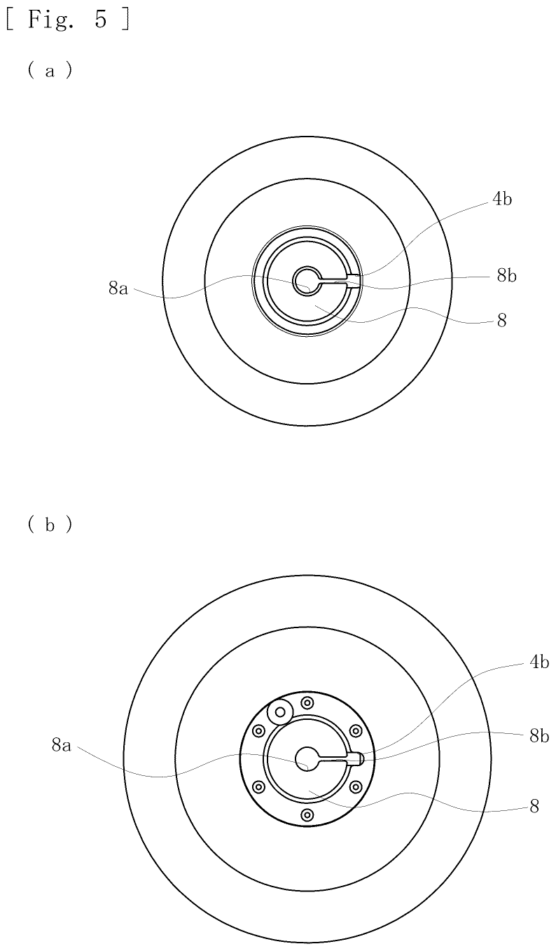

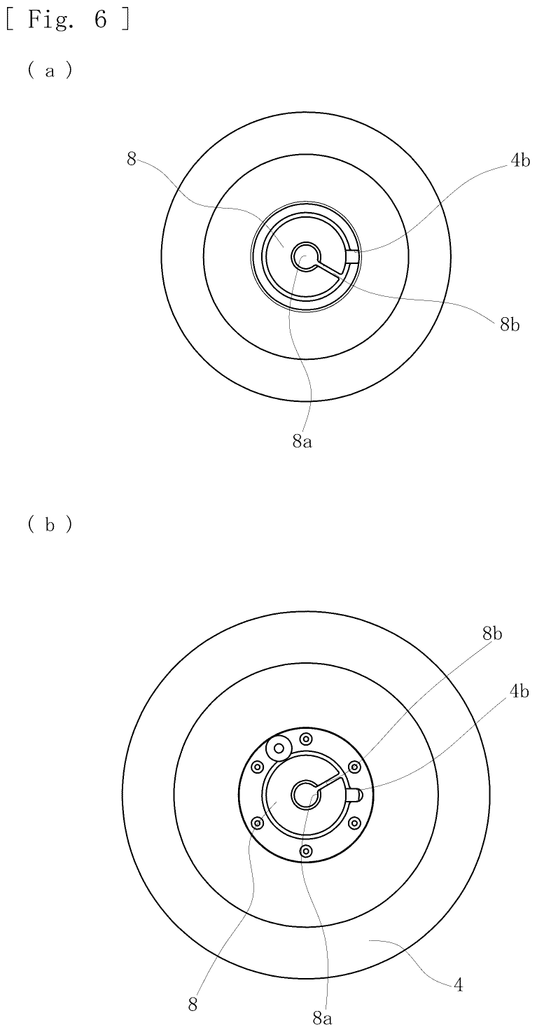

Moreover, because the shaft sleeve 8 according to the present embodiment has the slit 8b at a predetermined position, the output cable 7b can be inserted by using the slit 8b. Also, it can be prevented from coming off through the slit 8b by, after the output cable 7b is inserted through the insertion groove part 4b with the slit 8b being aligned with the insertion groove part 4b as illustrated in FIG. 5, displacing the slit 8b from the insertion groove part 4b by rotating the shaft sleeve 8 as illustrated in FIG. 6.

Next, a second embodiment according to the present disclosure will be described.

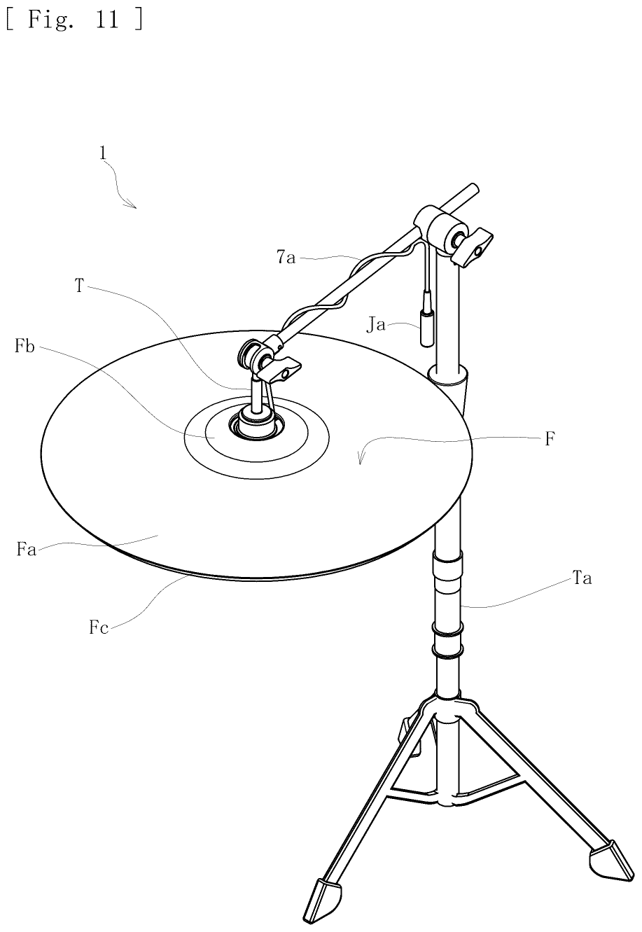

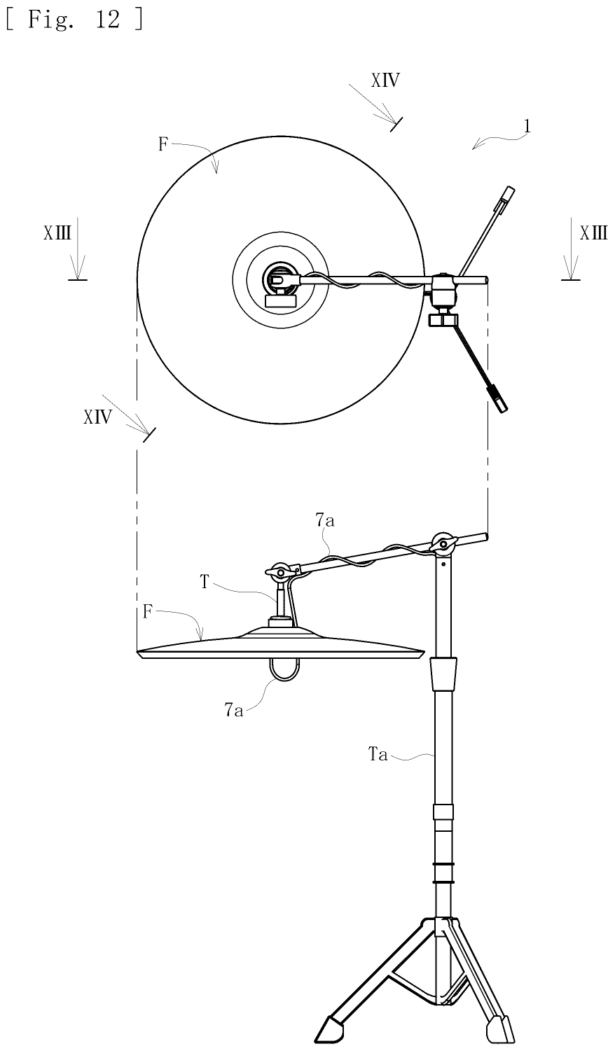

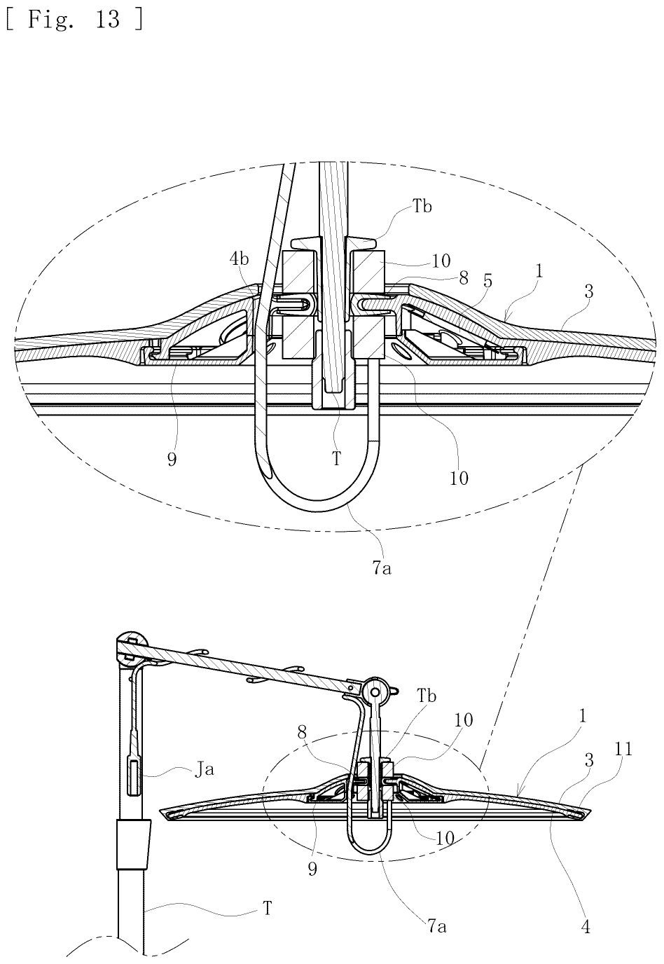

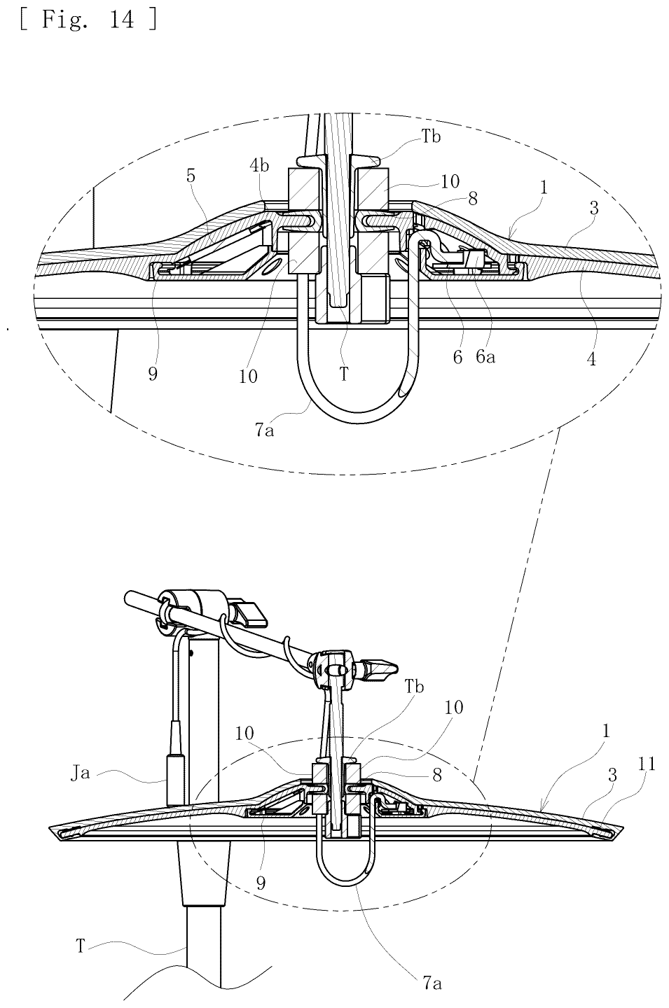

An electronic cymbal according to the second embodiment includes, as illustrated in FIGS. 11 to 14, an electronic cymbal body 1 suspended from and supported by a supporting stand T, a vibration sensor 5 (detection sensor) and a shaft sleeve 8 that are disposed in the electronic cymbal body 1, and a covering member 9. Note that the components having similar configurations to those of the components of the first embodiment are denoted by the same reference signs, and the detailed description thereof is omitted.

The electronic cymbal body 1, according to the present embodiment, is fixed to the supporting stand T extended downward from above the electronic cymbal body 1 and is supported in a suspended state. The electronic cymbal body 1 has an insertion groove part 4b that is formed so as to communicate with an opening part 4a of a frame 4. It holds an output cable 7a while it is inserted therethrough. As with the first embodiment, the insertion groove part 4b is constituted by a cutout formed in the periphery of the opening part 4a formed in the frame 4. The shaft sleeve 8 is attached while being interposed between the opening part 4a of the frame 4. The supporting stand T, a stand sleeve Tb.

That is, the electronic cymbal body 1 according to the present embodiment is suspended from and supported by the supporting stand T. The output cable 7a, extending from the electronic cymbal body 1, is inserted through the insertion groove part 4b. Thus, the output cable 7a, extending from the electronic cymbal body 1, can be routed along the supporting stand T while being held reliably at a center position of the electronic cymbal body 1, thereby being prevented from, during a performance, becoming an obstacle for a hitting surface F and degrading the appearance while being routed in midair.

According to each of the first and second embodiments described above, there is provided the insertion groove part 4b that is formed so as to communicate with the opening part 4a of the frame 4 and where the output cables (7a, 7b) can be held while being inserted therethrough. Thus, a problem during a performance can be avoided by holding the output cables (7a, 7b) even when the electronic cymbal bodies (1, 2) are arranged vertically at plural levels or even when the electronic cymbal body 1 is disposed in a suspended state.

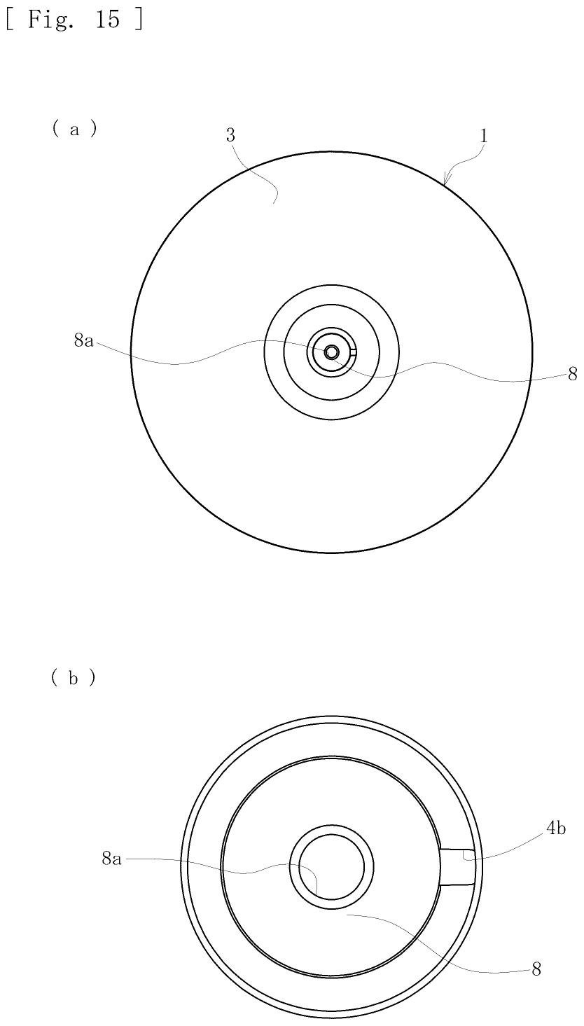

In addition, the insertion groove part 4b, according to each of the present embodiments, is formed in the periphery of the opening part 4a formed in the frame 4. The shaft sleeve 8 is attached while being interposed between the opening part 4a of the frame 4 and the supporting stand T. Thus, the shaft sleeve 8 can reliably hold the output cables (7a, 7b) inserted inside the insertion groove part 4b. Moreover, the shaft sleeve 8, according to each of the present embodiments, has the slit 8b at a position corresponding to the insertion groove part 4b. The output cables (7a, 7b) can be inserted through the insertion groove part 4b via the slit 8b. Thus, the output cables (7a, 7b) can be held inside the insertion groove part 4b while being inserted therethrough via the slit 8b, and assembling workability can be improved. Note that, as illustrated in FIG. 15, no slit 8b may be provided, and a shaft sleeve 8, detachably attached to the opening part 4a, may be used.

In particular, according to the first embodiment, the electronic cymbal bodies (1, 2) are supported by the supporting stand T vertically at plural levels (two levels). The output cable 7b, extending from the electronic cymbal body 2 at the upper level, is inserted through the insertion groove part 4b of the electronic cymbal body 1 at the lower level. Thus, the output cable 7b, extending from the electronic cymbal body 2 at the upper level, can be held in the insertion groove part 4b. Accordingly, erroneous detection of the vibration sensor 5 and performance interference can be prevented.

In addition, according to the second embodiment, the electronic cymbal body 1 is suspended from and supported by the supporting stand T. The output cable 7a, extending from the electronic cymbal body 1, is inserted through the insertion groove part 4b. Thus, the output cable 7a, extending from the suspended electronic cymbal body 1, can be held in the insertion groove part 4b and appearance degradation and performance interference can be prevented.

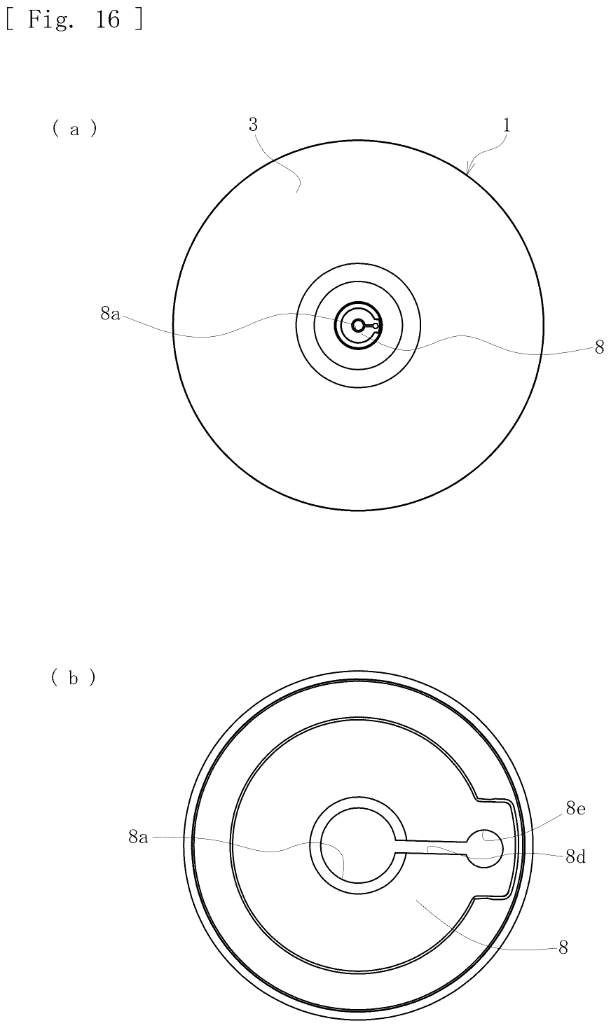

Although the present embodiments have so far been described, the present disclosure is not limited thereto. For example, as illustrated in FIG. 16, a shaft sleeve 8 may have an insertion groove part 8e. In addition, the shaft sleeve 8 has a slit part 8d and the insertion groove part 8e that are formed contiguously to a central hole 8a. The output cables (7a, 7b) can be inserted through the insertion groove part 8e via the slit part 8d and can be held in the insertion groove part 8e. As described above, with the configuration where the shaft sleeve 8 is attached to the opening part 4a formed in the frame 4, and the shaft sleeve 8 has the insertion groove part 8e, the output cables (7a, 7b) can be held in the insertion groove part 8e of the shaft sleeve 8 without forming an insertion groove part 4b in the electronic cymbal body 1.

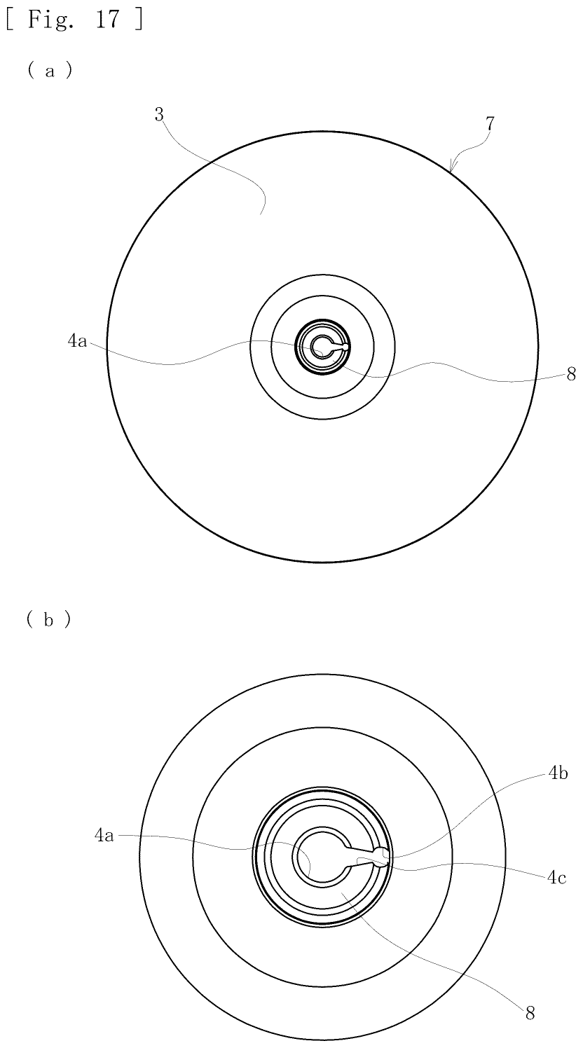

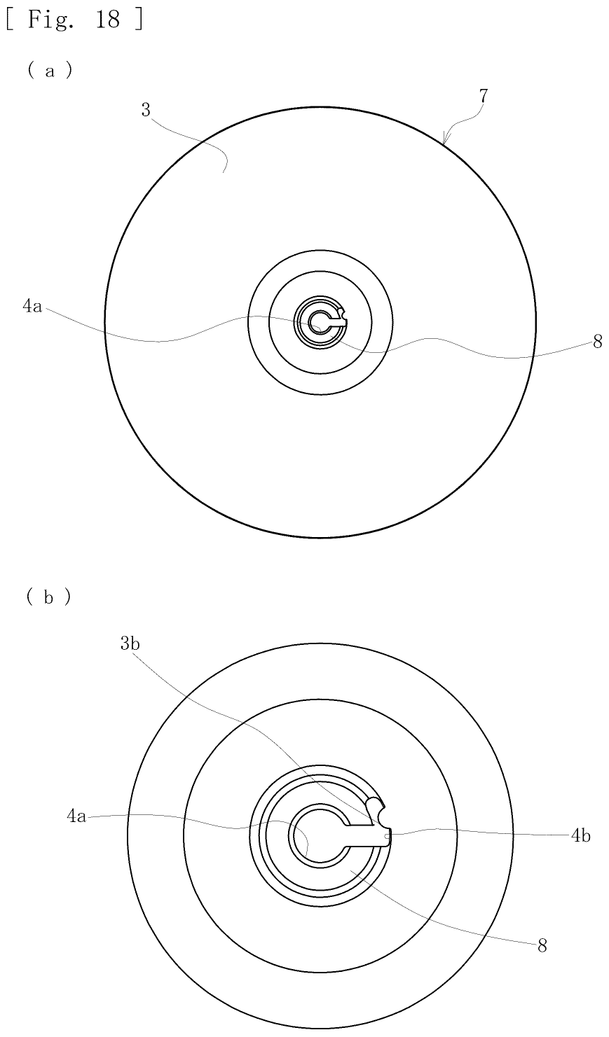

In addition, no shaft sleeve 8 may be provided, and, in this case, the insertion groove part 4b is preferably provided with a retaining shape with which the output cables (7a, 7b), that are inserted therethrough, can be retained. In this case, the output cables (7a, 7b), held in the insertion groove part 4b, may be retained, for example, as illustrated in FIG. 17, by forming a retaining shape 4c (narrow part) having a small width dimension at a position between the opening part 4a and the insertion groove part 4b in the frame 4, or, as illustrated in FIG. 18, by communicating, in the frame 4, the opening part 4a and an insertion groove part 4b, having an L shape with each other, and by forming, in the pad 3, a retaining shape 3b protruding to the insertion groove part 4b. As described above, with the configurations including the retaining shapes 4c and 3b, for retaining the output cables (7a, 7b) inserted through the insertion groove parts 4b, the output cables (7a, 7b) inserted inside the insertion groove parts 4b can be held more reliably.

Note that, in the present embodiments, although aspects of the present disclosure are applied to the configuration where the electronic cymbal bodies (1, 2) are supported by the supporting stand T vertically at plural levels (two levels) or the configuration in which the electronic cymbal body 1 is suspended from and supported by the supporting stand T, the electronic cymbal body may be supported in another form. In addition, in the first embodiment, the electronic cymbal body 1 alone may be supported by the supporting stand T, and the electronic cymbal body 1 may be used alone while there is provided the insertion groove part 4b through which the output cable 7a of the electronic cymbal body 1 can be inserted. However, although the insertion groove part 4b is formed only in the frame 4 in each of the present embodiments, a groove part through which the output cables (7a, 7b) can be inserted may also be formed in the pad 3 at a position corresponding to the insertion groove part 4b.

Moreover, although the output jacks (Ja, Jb) are formed at the distal ends of the output cables (7a, 7b) in the present embodiments, the output jacks (Ja, Jb) may be formed inside the electronic cymbal bodies (1, 2). The output cables (7a, 7b) may be extended from the output jacks (Ja, Jb), or direct connection to the external signal processing device may be made without using the output jacks (Ja, Jb). Note that the output cables (7a, 7b) may be capable of communicating, in addition to the electrical signals output by the vibration sensors 5, various types of signals including input signals.

Aspects of the present disclosure are applicable to an electronic cymbal with a different exterior shape or an electronic cymbal where another function is added, as long as the electronic cymbal has an insertion groove part. The insertion groove part is formed so as to communicate with an opening part of a frame and where an output cable can be held while being inserted therethrough.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic cymbal comprising:
an electronic cymbal body including a pad having a hitting surface that a player can hit and a frame supporting a back surface side of the pad;
opening parts that are formed at centers of the pad and the frame of the electronic cymbal body and through which a supporting stand can be inserted;
a detection sensor detecting a hit on the hitting surface of the pad;
an output cable connected to the detection sensor and through which a detection signal, detected by the detection sensor, can be output; and
the electronic cymbal has an insertion groove part communicating with the opening part of the frame where the output cable can be held while being inserted through the insertion groove part.

2. The electronic cymbal according to claim 1, wherein
the insertion groove part is formed in a periphery of the opening part formed in the frame, and a shaft sleeve is attached while being interposed between the opening part of the frame and the supporting stand.

3. The electronic cymbal according to claim 2, wherein
the shaft sleeve has a slit at a position corresponding to the insertion groove part, and the output cable can be inserted through the insertion groove part via a slit.

4. The electronic cymbal according to claim 1, wherein
a shaft sleeve is attached to the opening part formed in the frame, and the insertion groove part is formed in the shaft sleeve.

5. The electronic cymbal according to claim 1, wherein
a retaining shape is formed for retaining the output cable inserted through the insertion groove part.

6. The electronic cymbal according to claim 1, wherein
the electronic cymbal comprises a plurality of the electronic cymbal bodies supported by the supporting stand vertically at a plurality of levels, and the output cable extending from the electronic cymbal body at an upper level is inserted through the insertion groove part of the electronic cymbal body at a lower level.

7. The electronic cymbal according to claim 1, wherein
the electronic cymbal body is suspended from and supported by the supporting stand, and the output cable, extending from the electronic cymbal body, is inserted through the insertion groove part.
